(19) United States
(12) Patent Application Publication
(10) Pub. No.: US 2007/0019764 A1
(43) Pub. Date: Jan. 25, 2007

(54) ANTENNA DIVERSITY DEVICE AND METHOD IN TERRESTRIAL DIGITAL MULTIMEDIA BROADCASTING

(76) Inventors: Hyun Po Yang, (US); Jae Hee Kwon, (US); Byong Yong Kong, (US)

Correspondence Address: IPLA P.A., 3580 WILSHIRE BLVD., 17TH FLOOR, LOS ANGELES, CA, 90010, US

(21) Appl. No.: 11/423,069

(22) Filed: Jun. 8, 2006

(30) Foreign Application Priority Data
Jul. 20, 2005 (KR) 10-2005-0065545

(51) Int. Cl. H04B 7/10

(52) U.S. Cl. 375/347

(57) ABSTRACT

An antenna diversity device and method in a terrestrial digital multimedia broadcasting (DMB) is provided. In a DMB receiver, the device includes: a BER measuring unit for receiving DMB data, measuring a BER of the received DMB data, and transmitting the measured BER to a MICOM (Micro COMputer) to realize antenna diversity for securing a deviation of a reception sensitivity, which can occur when a car is moved, and a quality of reception; the MICOM for controlling a general operation of the DMB receiver, and receiving the measured BER from the BER measuring unit and controlling the antenna diversity depending on the received BER; and an antenna switching unit for sequentially switching to the antenna having the best reception state among the plurality of antennas under the control of the MICOM.

### BACKGROUND OF THE INVENTION

1. Field of the Invention

The present invention relates to an antenna diversity device and method in a terrestrial digital multimedia broadcasting (DMB), and more particularly, to an antenna diversity device and method in a DMB, for overcoming a reception deviation varied depending on a car position and improving a reception rate so as to allow the vehicular DMB to be in a normal optimal reception state.

2. Description of the Related Art

In a conventional analog broadcasting, diversity is realized and a radio wave is received using an intensity of an electric field of the radio wave, but in a conventional DMB (terrestrial digital multimedia broadcasting), simply because the radio wave has a strong electric field, the broadcasting is not provided in a good state. Therefore, a conventional art has a drawback when the diversity is realized.

In other words, the DMB uses a very high frequency (VHF) bandwidth of the radio wave, but has digital data using a coded orthogonal frequency division multiplexing (COFDM) method being an actual modulation method. Therefore, it cannot be said that the digital data is in a good state simply because the radio wave has the strong electric field.

### SUMMARY OF THE INVENTION

Accordingly, the present invention is directed to an antenna diversity device and method in a terrestrial digital multimedia broadcasting that substantially overcomes one or more of the limitations and disadvantages of the conventional art.

One object of the present invention is to provide an antenna diversity device and method in a DMB, for receiving a signal from a radio frequency (RF) tuner of a DMB receiver, calculating a bit error rate (BER) of the received signal in a channel decoder chip, and switching to an optimal antenna using the calculated BER of the received signal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an antenna diversity device in a DMB (terrestrial digital multimedia broadcasting) in a DMB receiver having a plurality of antennas, a tuner, an A/D (analog to digital) converter, a demodulator, a channel decoder, an audio decoder, a data decoder, an outer decoder, and a DMB decoder, the device including: a BER measuring unit for receiving DMB data, measuring a BER of the received DMB data, and transmitting the measured BER to a MICOM (Micro COMputer) to realize antenna diversity for securing a deviation of a reception sensitivity, which can occur when a car is moved, and a quality of reception; the MICOM for controlling a general operation of the DMB receiver, and receiving the measured BER from the BER measuring unit and controlling the antenna diversity depending on the received BER; and an antenna switching unit for sequentially switching to the antenna having the best reception state among the plurality of antennas under the control of the MICOM.

In another aspect of the present invention, there is provided an antenna diversity method in a DMB (terrestrial digital multimedia broadcasting), the method including the steps of: receiving signals from a plurality of antennas equipped with an antenna switching unit; checking BERs (bit error rates) of the received signals; and switching to the antenna having the best reception state of the BER.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating a system construction of a DMB receiver having an antenna diversity device according to an embodiment of the present invention; and

FIG. 2 is a flowchart illustrating an operation flow of a DMB receiver having an antenna diversity device according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

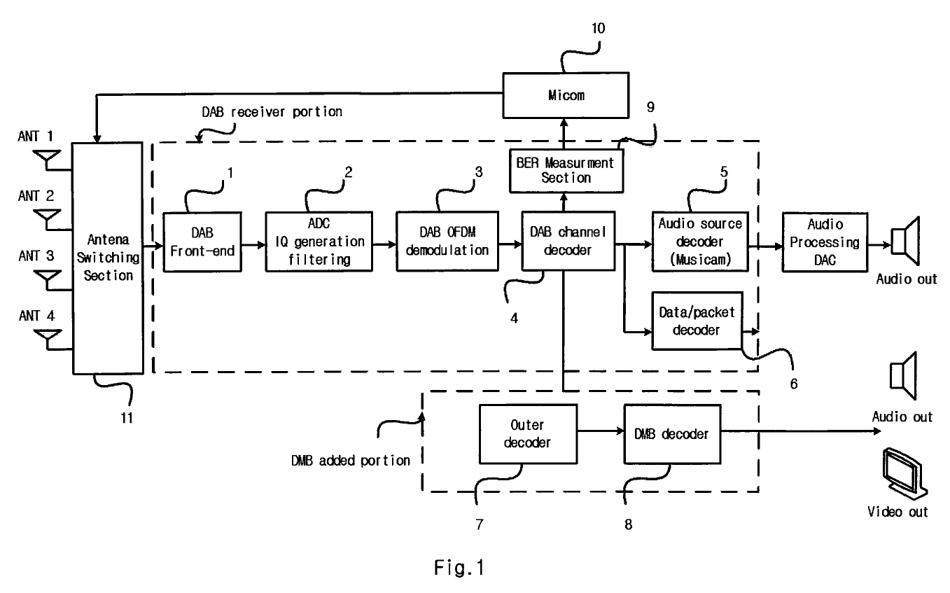

FIG. 1 is a block diagram illustrating a system construction of a DMB receiver having an antenna diversity device according to an embodiment of the present invention.

In addition to the DMB receiver including a plurality of antennas (ANT1 to ANT4), a tuner 1, an analog to digital (A/D) converter 2, a demodulator 3, a channel decoder 4, an audio decoder 5, a data decoder 6, an outer decoder 7, and a DMB decoder 8, the inventive antenna diversity device further includes a BER measuring unit 9 for receiving DMB data, measuring a BER of the received DMB data, and transmitting the measured BER to a Micro COMputer (MICOM) 10 to realize antenna diversity for securing a deviation of a reception sensitivity, which can occur when a car is moved, and a quality of reception; the MICOM 10 for controlling a general operation of the DMB receiver and, in particular, controlling the antenna diversity depending on the BER received from the BER measuring unit 9; and an antenna switching unit 11 for sequentially switching to the antenna having the best reception state among the plurality of antennas under the control of the MICOM 10.

Specifically, the BER measuring unit 9 measures a state of the BER at an input or output terminal of the channel decoder 4. The reason why the BER is measured in the input or output terminal is that, if the BER is measured at the outer decoder 7, it takes three or four minutes to check and measure an amount of data of 10⁻⁸ at a transfer rate of 500 Kbps, thereby making it impossible to measure the data in real time. Therefore, in actual, the DMB antenna cannot realize a function of the diversity depending on the BER value. Accordingly, a method of measuring the data in real time in a channel decoder 4 portion using a value of 2×10⁻⁴ is used.

Each of the antennas (ANT1 to ANT4) has an independent matching circuit and therefore, even though connection is made to any antenna, the connection is not degraded in reception sensitivity and has no influence from other antennas. Further, when other general television (TV) functions are used through a mode change, it can be realized to open with the DMB receiver and be commonly used with a general analog TV.

The tuner 1 selects a DMB signal, and performs synchronization. The tuner 1 receives the DMB signal through any one of the plurality of antennas (ANT1 to ANT4), and detects a base band signal of a desired channel from the received DMB signal.

The A/D converter 2 receives an analog DMB through the tuner 1, and converting the received analog DMB into a digital DMB.

The demodulator 3 receives the digital signal from the A/D converter 2, performs a Fast Fourier Transform (FFT) of the received digital signal, and performs a differential demodulation of the FFT digital signal.

The channel decoder 4 receives the digital signal from the demodulator 3, and de-interleaves the received signal at a time and frequency region. When the audio decoder 5, the data decoder 6, and the DMB decoder 8 restore transmission data through error correction decoding, a complex data signal including audio and video signals is finally obtained. At this time, a basic digital audio broadcasting (DAB) audio data is MPEG-decoded and separated as left and right signals, and DMB video data is separately video (H.264) and audio (BSAC) decoded and service data is finally obtained.

Meantime, in preparation for various error causes that can occur in a process of modulating and then transmitting the data at a transmitting side, in a basis audio service, a convolutional code-based rate compatible punctured code (RCPC) is used in an error correction encoding method, and an interleaving technology for preventing a burst error of audio and data is used (BER=10E(−4)).

In a video service, in order to guarantee a relationship of BER=10E(−8) for quality security, 16 bytes are added to a 188 byte TS packet in an outer encoder, and an error coding is inserted. Even though a RF waveform is varied or has a little weak electric field while the above-modulated signal is transmitted through a transmission network, if the variation or the weak electric field is within a range where the signal can be normally demodulated in the demodulator 3 of the DMB receiver, the tuner 1 can restore an original signal. This is a great difference with an analog TV broadcasting where the waveform has any variation or has the weak electric field.

Accordingly, according to the present invention, the DMB receiver uses a diversity method in which the diversity is embodied using the BER most basically evaluating as to how much reception data is damaged, the BER is checked, and the antenna diversity is performed depending on the state of the checked BER.

In general, the DMB receiver has a BER reference of 10E(−4) in the basic DAB audio (MUSICAM), and has a BER reference of 10E(−8) in the video. In the basic audio, a measurement value is obtained in real time from the channel decoder 4. However, in the video service, a measurement value is obtained from a latter part of the outer decoder 7, and is a value including even a video image.

However, in the DMB data having a relatively low bit rate, a numeric of 10E(−8) is a large amount of data. Accordingly, there is a drawback in that, when one of bits is damaged, it is difficult to perform a real-time calculation in an actual measurement environment. Therefore, the present invention uses an alternative method in which a channel decoder 4 portion, not the outer decoder 7, measures an actual BER in quality with a reference BER of 2×10E(−4).

Accordingly, since a minimal time taken to measure a stream of about 500 Kbps is almost real time, it makes possible to perform the antenna diversity using the BER checking method.

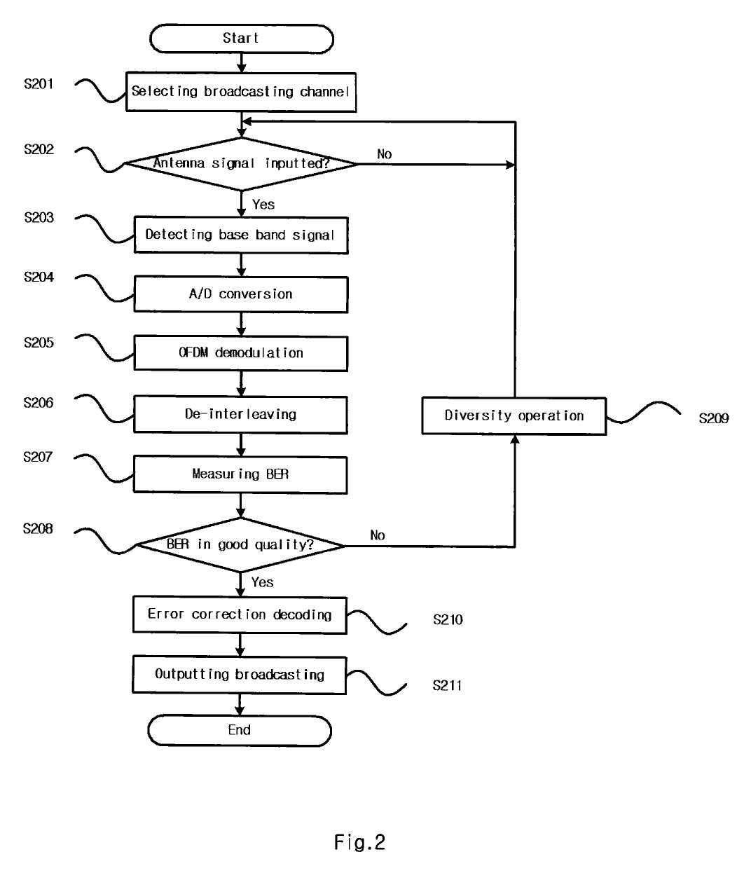

In the DMB receiver having the inventive above constructed antenna diversity device, the quality of the data is evaluated on the basis of the calculated BER of the received data in the broadcasting where transmission and reception systems are all digital types, not on the basis of the diversity using the intensity of the electric field of the radio wave in the general analog broadcasting. A procedure of the diversity of the DMB receiver will be in detail described below with reference to FIG. 2.

First, if a power source is applied to the DMB receiver installed at the car and a user select a broadcasting channel, the antenna switching unit 11 receives the DMB signal from one (ANTI) of the plurality of antennas under the control of the MICOM 10 (Step 201).

After that, the tuner 1 determines whether or not to receive the DMB signal from the antenna (Step 202) and, if it is determined to receive the DMB signal, detects the base band signal of the desired channel from the DMB signal (Step 203). The A/D converter 2 converts the base band signal into a digital signal, and outputs the digital signal to the orthogonal frequency division multiplexing (OFDM) demodulator 3 (Step 204).

Next, the OFDM demodulator 3 receives the digital signal from the A/D converter 2, performs the FFT of the received digital signal, and differential demodulates the FFT signal (Step 205). The channel decoder 4 receives the signal from the OFDM demodulator 3, and de-interleaves the received signal at the time and frequency region (Step 206).

After that, the BER measuring unit 9 receives bit stream data, temporarily stores the received bit stream data in a buffer, measures the BER using the stored data, and transmits the measured BER to the MICOM 10 (Step 207). At this time, the storing of the data in the buffer should be performed at the same time of measuring the BER. therefore, thread is used.

The MICOM 10 receives the measured BER from the BER measuring unit 9, compares the received BER with a reference value, and determines a quality of the broadcasting signal received from the antenna (ANT1) (Step 208). If the measured BER is out of the reference value, the diversity is activated (Step 209).

In other words, under the control of the MICOM 10, the antenna switching unit 11 sequentially switches to the next one (ANT2) of the plurality of antennas (ANT1 to ANT4), and the above Steps 202 to 209 are again repeated until the BER satisfying the required reference value is measured.

Accordingly, at the time of receiving the DMB signal within the moving car, continuous connection can be made to the antenna having the best reception state among the plurality of antennas. Therefore, an operation can be made correspondingly to the deviation of the reception sensitivity varied depending on a direction and a position of the car.

Meantime, if it is determined in the Step 208 that the measured BER is within the reference value and the broadcasting signal is good in quality, the antenna diversity is not activated and, in the audio decoder 5, the data decoder 6, and the DMB decoder 8, the transmission data is error correction decoded and restored under the control of the MICOM 10 (Step 210) and the complex data signal including the audio signal and image is finally obtained, and the signals are reproduced through each speaker and monitor (Step 211).

As described above, the present invention has an advantage in that, when the DMB signal is used at the car, in order to improve the reception quality varied depending on the deviation of the reception sensitivity varied depending on the movement position of the car, the BER of the RF modulated and loaded data is checked and the diversity is embodied depending on the BER, thereby maintaining the DMB signal to be in the best reception state even in course of driving.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An antenna diversity device in a DMB (terrestrial digital multimedia broadcasting) in a DMB receiver having a plurality of antennas, a tuner, an A/D (analog to digital) converter, a demodulator, a channel decoder, an audio decoder, a data decoder, an outer decoder, and a DMB decoder, the device comprising:
a BER measuring unit for receiving DMB data, measuring a BER of the received DMB data, and transmitting the measured BER to a MICOM (Micro COMputer) to realize antenna diversity for securing a deviation of a reception sensitivity, which can occur when a car is moved, and a quality of reception;
the MICOM for controlling a general operation of the DMB receiver, and receiving the measured BER from the BER measuring unit and controlling the antenna diversity depending on the received BER; and
an antenna switching unit for sequentially switching to the antenna having the best reception state among the plurality of antennas under the control of the MICOM.

2. An antenna diversity method in a DMB (terrestrial digital multimedia broadcasting), the method comprising the steps of:
receiving signals from a plurality of antennas equipped with an antenna switching unit;
checking BERs (bit error rates) of the received signals; and switching to the antenna having the best reception state of the BER.
